(19) United States
(12) Patent Application Publication
(10) Pub. No.: US 2010/0066046 A1
(43) Pub. Date: Mar. 18, 2010

(54) Two Wheeled Dolly and Method for Transporting a Windowed Product

(76) Inventor: Robert P. Warunek, Clinton Township, MI (US)

Correspondence Address: GREGORY T. ZALECKI, 12900 HALL ROAD, SUITE 400, STERLING HEIGHTS, MI, 48313, US

(21) Appl. No.: 12/210,932

(22) Filed: Sep. 15, 2008

(51) Int. Cl. B62D 61/02

(52) U.S. Cl. 280/63

(57) ABSTRACT

A two wheeled dolly for transporting a windowed product across varied terrain is comprised of a platform, a nonslip surface, a pair of sidewalls, an axle, a pair of bearings and a pair of pneumatic tires. The platform is open-ended. One side wall extends upward from each longitudinal edge of the platform. The top of the platform has a nonslip surface. The axle is transversely attached to the platform and centered under the platform. A bearing and a pneumatic tire are attached to each end of the axle and adapted such that the tires rotate about the axle. In order to transport a windowed product, such as a doorwall, the windowed product is placed on its edge upon the platform such that it is substantially balanced over the axle. The windowed product can then be transported and maneuvered across varied terrain.

### BACKGROUND

The construction or renovation of new or existing residential, commercial and industrial buildings commonly requires the installation of windowed products such as doorwalls, doors and windows. It is not unusual for a doorwall to weigh 400 pounds. The windowed product must be delivered to the installation site. In the case of renovations, a windowed product which has been removed must be transported away from the installation site. Often, the windowed product, which may be cumbersome, must be moved across varied outdoor terrain which may be sloping, covered with grass or other vegetation, wet or covered with snow. These tasks may be difficult to perform, even when two workers are attempting to perform the tasks. The weight of the windowed product, which may be cumbersome, and the terrain may subject the windowed product to damage during transportation and may also subject the workers transporting the windowed product to physical injury. Even when the task is properly performed, it may require an undue amount of labor hours. What is needed is a device upon which a windowed product may be placed and transported. The device should allow the windowed product to be balanced upon it. The windowed product should be easily placed upon the device. The device should support the windowed product so that it does not bend or otherwise become damaged due to its weight and the effects of gravity. The device should allow the windowed product to be wheeled from one position to another. It should allow tight turns. It should be capable of transporting the windowed product up and down sloping terrain. It should protect the windowed product from damage caused by contact with a wheel of the device and from falling upon the ground.

### SUMMARY

The two wheeled dolly for transporting a windowed product across varied terrain satisfies these needs. It is comprised of a platform, two sidewalls, a nonslip surface, an axle, a pair of bearings and a pair of pneumatic tires. The platform is open ended. It is rectangular in form. Its longitudinal ends are open so that a windowed product can be easily moved longitudinally after it is placed upon the platform. One sidewall extends upward from each longitudinal edge of the platform. These sidewalls define an inner width of the platform positioned between the sidewalls. The sidewalls prevent the windowed product which is positioned on top of the platform from falling off of the side of the platform and from contacting one of the tires. Preferably, the length of the platform is approximately 24 inches and the inner width of the platform is approximately 8 inches. The top side of the platform has a nonslip surface. This prevents the windowed product resting upon the platform from moving longitudinally and tending to slip off of the platform. The axle is transversely attached to the bottom of the platform. The axis of the axle is perpendicular to the longitudinal axis of the platform. The axle is longitudinally centered under the platform. Thus, the platform easily balances over the axle. A bearing and a pneumatic tire are attached to each end of the axle. Each tire is adapted to rotate about the axle. Preferably, each tire is approximately 10 inches in diameter and 2¾″ wide.

The platform is adapted to pivot along the axle relative to the tires. The tires are sized such that the centerline of the axle will be between 4.5 inches and 8 inches above the surface upon which the tires rest. The distance between the outer aspects of the tires is between 10 inches and 20 inches. This would be the total width of the device as seen when viewing it from a top view. The length of the platform is between 20 inches and 36 inches. This will help prevent the bowing of a heavy windowed product which is placed upon the platform. The inner width of the platform is between 4.5 inches and 10 inches. This is the distance between the inside walls of the sidewalls. When the tires and one end of the platform rest upon a ground surface, the acute angle between the line where the platform contacts the ground surface, the centerline of the axle and the ground surface is between 20° and 45°. The aspect ratio of the platform length to the inner width of the platform is between 2.0 and 6.0.

In order to use the two wheeled dolly for transporting a windowed product across a varied terrain, a two wheeled dolly, as described, is selected. A windowed product, such as a doorwall, is selected. A route across the varied terrain for transporting the windowed product from a beginning point to a destination is determined. The windowed product is positioned upon the platform such that the windowed product is substantially balanced over the axle. The two wheeled dolly carrying the windowed product is rolled across the varied terrain from the beginning point to the destination.

### DRAWINGS

These and other features, aspects, and advantages of the present invention will become better understood with regard to the following description, appended claims, and accompanying drawings where:

FIG. 1 is a perspective view of a two wheeled dolly for transporting a windowed product across varied terrain with a windowed product positioned upon the platform of the dolly.

FIG. 2 is a perspective view of the two wheeled dolly of FIG. 1, without the windowed product.

FIG. 3 is an exploded perspective view of the two wheeled dolly of FIG. 1 and FIG. 2.

FIG. 4 is a top view of the two wheeled dolly of FIG. 2.

FIG. 5 is a front view of the two wheeled dolly and windowed product of FIG. 1.

### DESCRIPTION

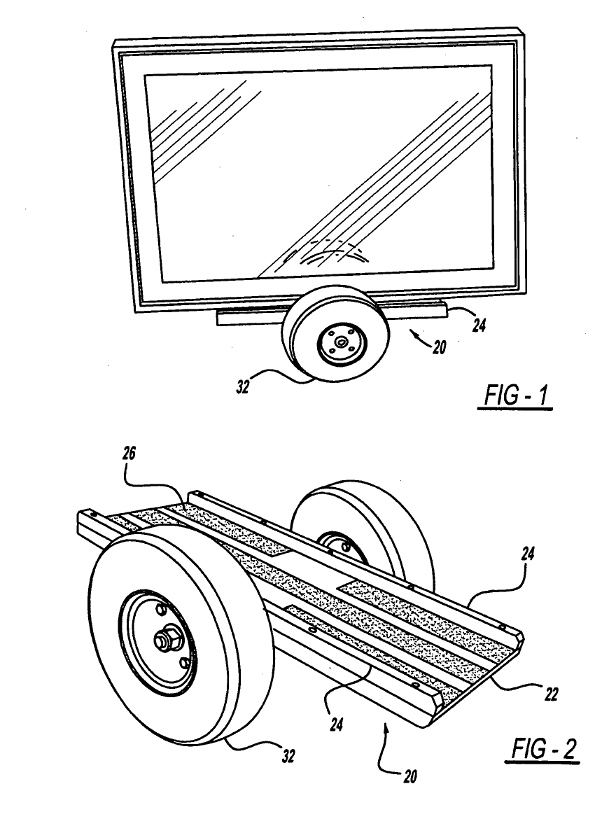

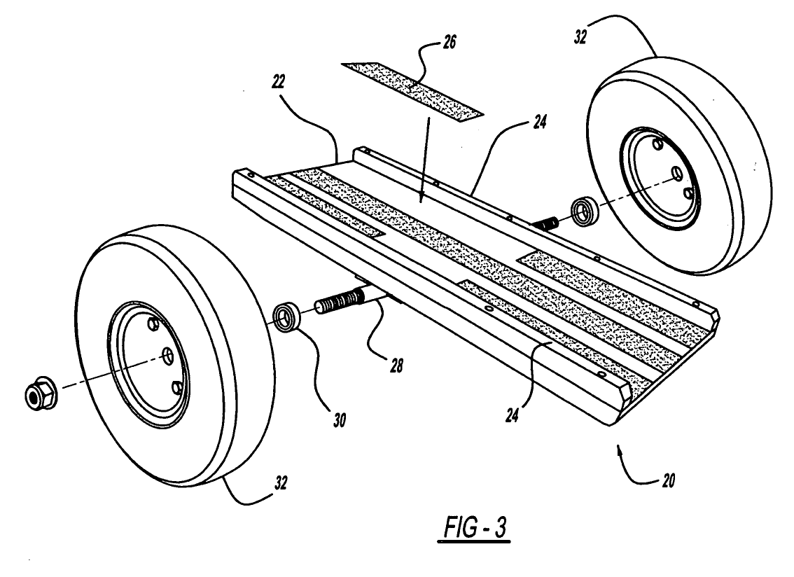

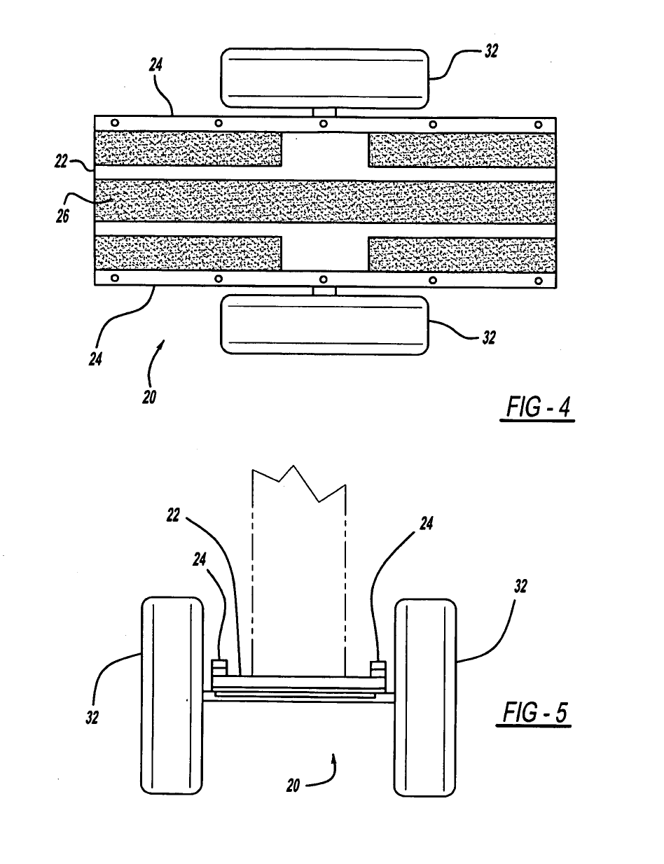

The preferred embodiment of a two wheeled dolly 20 for transporting a windowed product across varied terrain is shown in FIGS. 1-5. It is comprised of an open-ended platform 22, 2 sidewalls 24, a nonslip surface 26, an axle 28, a pair of bearings 30 and a pair of pneumatic tires 32. Windowed products include doorwalls, doors and windows.

The open-ended platform 22 is adapted to support a windowed product. Preferably, it is fabricated from wood which is ¾″ thick 24 inches long and 9½″ wide. The sidewalls 24 are also preferably fabricated from wood. They should be ¾″ by ¾″×24″. They are mounted to the outside longitudinal edges of the platform 24 such that an inner width, between the sidewalls 24, of approximately 8 inches, within the platform 22, is created and such that the outer longitudinal edges of the platform 22 and each sidewall 24 are coplanar. The platform 22 supports a windowed product and prevents it from bowing. The sidewalls 24 prevent the windowed product from slipping off of the platform 22 and into one of the tires 32. On my prototype, the sidewalls 24 are glued to the platform 22 and further secured by wood screws. It should be understood that my invention is not limited to the specific materials and methods of construction described herein. I have found that the platform 22 and sidewall dimensions 24 which I have described are optimal for transporting a 400 pound eight-foot doorwall within its shipping packaging.

The top side of the platform 22 has a nonslip surface 26. Preferably, the nonslip surface 26 is comprised of nonskid tape having an abrasive surface on one side and adhesive on the other. 3M Co. currently sells anti-slip tape which may be used on the top surface of the platform 22. It should also be understood that a nonslip surface may be embedded into the top of the platform 22. The nonslip surface 26 prevents the windowed product from moving longitudinally and tending to slip off of the platform 22 when the windowed product is being transported.

The axle 28 should be fabricated from steel and have threaded ends. The axle 28 may be welded to a rectangular flange which is as long as the platform 22 is wide. This will permit the axle 28 and flange to be secured to the underside of the platform 22 with wood screws. The axle 28 is transversely attached to the bottom of the platform 22. The axis of the attached axle 28 is perpendicular to the longitudinal axis of the platform 22. The axle 28 is longitudinally centered under the platform 22. Thus, for a 24 inch platform 22, the axis of the axle 28 would be 12 inches from each longitudinal end. The centering of the axle 26 under the platform 22 optimizes the performance of the dolly 20. It is much easier to balance a heavy windowed product upon such a platform 22. It is also much easier to make tight turns with the dolly 20 while it carries a heavy windowed product.

A wheel bearing 30 is affixed to each end of the axle 28. A pneumatic tire 32 is attached to each wheel bearing 30 and axle 28 end. The pneumatic tires 32 are adapted to rotate about the axis of the axle 28 upon a bearing surface provided by the bearings 30. Each tire 32 should be approximately 10 inches in diameter and 2¾″ wide. This provides sufficient clearance between the bottom edge of a heavy windowed product being carried by the dolly 20 and the ground. It also optimizes the ability of a heavily loaded platform 22 to be maneuvered across sloping rough terrain and the ability for such loaded platform 22/dolly 20 to be tightly (small radius) turned. Pneumatic tires 32 allow a heavy windowed product to be maneuvered much more easily, as compared to the effort required if the tires were solid. It should be clear that the platform 22 is adapted to pivot about the axle 28 relative to the tires 32. Although the preferred 10 inch diameter tires 32 will cause the centerline of the axle 28 to be positioned 5 inches above a surface upon which the tires 32 rest, I have concluded that distances between the centerline of the axle 28 and the surface upon which the tires 32 rest may range between 4.5 inches and 8 inches and still provide adequate performance. I have also concluded that the distance between the outer aspects of the tires 32 should be between 10 inches and 20 inches to provide adequate performance for the carrying of heavy doorwalls. This distance can be visualized from FIG. 5. This is a front view of a two wheeled dolly 20. The distance described is the distance between the outermost surfaces of the tires 32. In other words, this distance is the overall width of the device shown in FIG. 5.

One of the objectives of my invention is to not only ease the transportation of heavy windowed products, but also to prevent the bowing of those windowed products when they are set edgewise upon the platform 22. I have determined that the platform 22 should be between 20 inches and 36 inches in length to satisfy this need. The inner width of the platform 22 should be between 4.5 inches and 10 inches in order to allow a heavy doorwall to be carried, but at the same time to prevent the size and geometry of the dolly 20 from significantly interfering with its maneuverability. This inner width can also be visualized from FIG. 5. This Figure shows a U-shaped structure formed by the platform 22 and the sidewalls 24 within which the windowed product sets. The width of this U-shaped structure (i.e. the distance between the interior aspects of the sidewalls 24) is the described inner width.

I have determined that other geometric specifications pertaining to the two wheeled dolly 20 enhance its performance for carrying heavy windowed products. The unloaded platform 22 will tend to pivot along the axle 28 such that one end of the platform 22 will rest upon the same ground surface that the tires 32 rest upon. When the tires 32 and one end of the platform 22 rest upon a ground surface, the acute angle between the line where the platform 22 contacts the ground surface, the centerline of the axle 28 and the ground surface (i.e. ground plane) is between 20° and 45°. The preferred angle can be determined trigonometrically. The axle 28 rests 5.0 inches over the ground surface. The distance between the ground surface line upon which the platform 22 rests and the centerline of the axle 28 is one half of the platform 22 length—or 12 inches. Thus, the defined angle is the inverse sine of 5/12. This is 24.6°. Therefore, the preferred angle is 24.6°. Preferably, the aspect ratio of the platform 22 length to the inner width of the platform 22 is between 2.0 and 6.0.

In order to transport a windowed product across varied terrain a two wheeled dolly 20, as described, is selected. A windowed product, such as a heavy doorwall is selected. A route across a varied terrain for transporting the window product from a beginning point to a destination is determined. The windowed product is positioned upon the platform 22 such that it is substantially balanced over the axle 28. The two wheeled dolly 20 is rolled across the varied terrain from the beginning point to the destination. At the destination, the windowed product is removed from the two wheeled dolly 20. In the case of a building renovation, a windowed product which has been removed may be similarly transported from the destination to the beginning point.

The two wheeled dolly 20 described herein differs from other dollies designed for transporting plate glass or stone slabs. The described dolly 20 has only two tires 32, while others often have four or more. The described dolly 20 has no casters. The axle 28 of the describe dolly 20 is centered under the platform 22, while prior art dollies have their axles offset from the transverse centerline of the platform. The centered axle 28 allows a heavy windowed product to be much more easily balanced upon the platform 22. The described dolly 20 has pneumatic tires 32, while prior art glass and stone slab dollies typically have solid wheels. The pneumatic tires 32 enhance and optimize the ability of the described dolly 20 to transport a heavy windowed product across varied terrain and through tight turns. Prior art dollies often have support structures, such as a peg, which are adapted to support their loads in a horizontal orientation. The described dolly 20 has no support peg. The length to inner width aspect ratio of the described two wheeled dolly 20 is between 2.0 and 6.0, while prior art glass and stone slab dollies typically have length to inner width aspect ratios between 10.0 and 25.0. The purpose of the described dolly 20 is to assist in the transportation of windowed products such as doorwalls, doors and windows. These windowed products are usually transported with their sale and distribution packaging intact. This means that the windowed products can withstand limited contact with the ground during transportation. This is not true for glass and stone slabs being transported by dollies adapted for their transport. The closest prior art dollies are designed and optimized for the transport of glass and stone slabs, not packaged windowed products. Therefore, prior art glass dollies typically have inner widths between 2½ inches and 4 inches. The described two wheeled dolly 20 has a larger inner width which is typically between 4½ inches and 10 inches. The distance between the bottom of the platform and the ground of prior art glass dollies is usually much less than 4 inches, while the distance between the bottom of the platform 22 and the ground of the describe dolly 20 is between 4.5 inches and 8 inches.

Although the invention has been shown and described with reference to certain preferred embodiments and methods, those skilled in the art undoubtedly will find alternative embodiments and methods obvious after reading this disclosure. With this in mind, the following claims are intended to define the scope of protection to be afforded the inventor, and those claims shall be deemed to include equivalent constructions insofar as they do not depart from the spirit and scope of the present invention.

What is claimed is:

1. A two wheeled dolly for transporting a windowed product across varied terrain, said dolly consisting essentially of:
(a) an open ended platform for supporting the windowed product;
(b) a sidewall extending upward from each longitudinal edge of the platform for retaining the windowed product within the platform, said sidewalls defining an inner width of the platform positioned between the sidewalls;
(c) a nonslip surface on the top side of the platform for preventing the windowed product from slipping off of the platform;
(d) an axle transversely attached to the platform, said axle being longitudinally centered under the platform;
(e) a pair of bearings, one of such pair of bearings being attached to each end of the axle; and
(f) a pair of pneumatic tires, one of such pair of tires being attached to each end of the axle and its respective bearing and being adapted to rotate about the axle; wherein:
(i) the platform is adapted to pivot along the axle relative to the tires;
(ii) the tires are sized such that the centerline of the axle will be between 4.5 inches and 8 inches above a surface upon which the tires rest;
(iii) the distance between the outer aspects of the tires is between 10 inches and 20 inches;
(iv) the length of the platform is between 20 inches and 36 inches for preventing bowing of a windowed product;
(v) the inner width of the platform is between 4.5 inches and 10 inches;
(vi) when the tires and one end of the platform rest upon a ground surface, the acute angle between the line where the platform contacts the ground surface, the centerline of the axle and the ground surface is between 20° and 45°; and
(vii) the aspect ratio of the platform length to the inner width of the platform is between 2.0 and 6.0.

2. The dolly for transporting a windowed product across varied terrain of claim 1, wherein each tire is approximately 10 inches in diameter and 2¾″ wide, the platform length is approximately 24 inches and the inner width of the platform is approximately 8 inches.

3. The dolly for transporting a windowed product across varied terrain of claim 1, wherein each tire is approximately 10 inches in diameter and 2¾″ wide.

4. The dolly for transporting a windowed product across varied terrain of claim 1, wherein the platform length is approximately 24 inches.

5. The dolly for transporting a windowed product across varied terrain of claim 1, wherein the inner width of the platform is approximately 8 inches.

6. A method for transporting a windowed product across varied terrain, said method comprising the steps of:
(a) selecting a two wheeled dolly for transporting a windowed product across varied terrain, said dolly consisting essentially of:
(i) an open ended platform for supporting the windowed product;
(ii) a sidewall extending upward from each longitudinal edge of the platform for retaining the windowed product within the platform, said sidewalls defining an inner width of the platform positioned between the sidewalls;
(iii) a nonslip surface on the top side of the platform for preventing the windowed product from slipping off of the platform;
(iv) an axle transversely attached to the platform, said axle being longitudinally centered under the platform;
(v) a pair of bearings, one of such pair of bearings being attached to each end of the axle; and
(vi) a pair of pneumatic tires, one of such pair of tires being attached to each end of the axle and its respective bearing and being adapted to rotate about the axle; wherein:
(1) the platform is adapted to pivot along the axle relative to the tires;
(2) the tires are sized such that the centerline of the axle will be between 4.5 inches and 8 inches above a surface upon which the tires rest;
(3) the distance between the outer aspects of the tires is between 10 inches and 20 inches;
(4) the length of the platform is between 20 inches and 36 inches for preventing bowing of a windowed product;
(5) the inner width of the platform is between 4.5 inches and 10 inches;
(6) when the tires and one end of the platform rest upon a ground surface, the acute angle between the line where the platform contacts the ground surface, the centerline of the axle and the ground surface is between 20° and 45°; and
(7) the aspect ratio of the platform length to the inner width of the platform is between 2.0 and 6.0;
(b) selecting a windowed product;
(c) determining a route across the varied terrain for transporting the windowed product from a beginning point to a destination;
(d) positioning the windowed product upon the platform such that it is substantially balanced over the axle; and
(e) rolling the two wheeled dolly across the varied terrain from the beginning point to the destination.

7. The method for transporting a windowed product across varied terrain of claim 7, wherein each tire is approximately 10 inches in diameter and 2¾″ wide, the platform length is approximately 24 inches and the inner width of the platform is approximately 8 inches.
